(19) United States
(12) Patent Application Publication
(10) Pub. No.: US 2025/0380024 A1
(43) Pub. Date: Dec. 11, 2025

(54) CONTENT AND/OR CONTROL USER INTERFACES

(71) Applicant: Apple Inc., Cupertino, CA (US)

(72) Inventors: Elbert D. CHEN, Cupertino, CA (US); Neil P. CORMICAN, Menlo Park, CA (US)

(21) Appl. No.: 19/210,799

(22) Filed: May 16, 2025

Related U.S. Application Data
(60) Provisional application No. 63/657,584, filed on Jun. 7, 2024.

(51) Int. Cl. H04N 21/431; H04N 21/422; H04N 21/472

(52) U.S. Cl. CPC H04N 21/4316; H04N 21/42204; H04N 21/47217

(57) ABSTRACT

Some embodiments are directed to user interfaces displayed by a first device in connection with first content being played at a second device. In some embodiments, the first device displays a first user interface that includes, if the first content includes a first sub-content item at a current playback position of the first content, a representation of the first sub-content item, and a first selectable option that is selectable to add the first sub-content item to a library of a user of the first device. In some embodiments, if the first content includes a second sub-content item, different from the first sub-content item, at the current playback position of the first content, the first user interface includes a representation of the second sub-content item, and a second selectable option that is selectable to add the second sub-content item to the library of the user of the first device.

### CROSS REFERENCE TO RELATED APPLICATIONS

This application claims the benefit of U.S. Provisional Application No. 63/657,584, filed Jun. 7, 2024, the content of which is herein incorporated by reference in its entirety for all purposes.

### FIELD OF THE DISCLOSURE

This relates generally to one or more user interfaces of a first electronic device in communication with a second electronic device.

### BACKGROUND

User interaction with electronic devices has increased significantly in recent years. These devices can be devices such as computers, tablet computers, televisions, multimedia devices, mobile devices, and the like.

In some circumstances, a user wishes to interact with a first electronic device in connection with operations being performed at a second electronic device, such as in connection with content being played by that second electronic device. In some circumstances, it would be beneficial to enhance the functionality provided at the first electronic device as it relates to the second electronic device. Enhancing such functionality reduces the need for user input to the first electronic device and/or the second electronic device, which is particularly important where devices are battery-operated.

### SUMMARY

Some embodiments described in this disclosure are directed to one or more methods for facilitating interaction with a first electronic device in connection with operations being performed at a second electronic device, such as the second electronic device playing content (e.g., video content, audio content, or the like). The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIGS. 5A-5C illustrate block diagrams of exemplary architectures for devices according to some embodiments of the disclosure.

FIGS. 6A-6L illustrate exemplary ways of displaying and/or facilitating interaction with user interfaces displayed by a first electronic device in connection with content being played back at a second electronic device in accordance with some embodiments of the disclosure.

FIG. 7 is a flow diagram illustrating a method of displaying and/or facilitating interaction with user interfaces displayed by a first electronic device in connection with content being played back at a second electronic device in accordance with some embodiments of the disclosure.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

Providing efficient ways of performing operations at a first electronic device in connection with operations being performed at a second electronic device enhances, and makes more efficient, user interactions with the first electronic device and/or the second electronic device-which reduces the computing resources needed by the first electronic device and/or the second electronic device. In some embodiments, while the first electronic device is in communication with a second electronic device that is currently playing first content, the first electronic device displays, via a display generation component, a first user interface that includes, in accordance with a determination that the first content includes a first sub-content item at a current playback position of the first content, a representation of the first sub-content item, and a first selectable option that is selectable to add the first sub-content item to a library of a user of the first electronic device. In some embodiments, while the first electronic device is in communication with the second electronic device that is currently playing the first content, the first electronic device displays, via the display generation component, the first user interface that includes, in accordance with a determination that the first content includes a second sub-content item, different from the first sub-content item, at the current playback position of the first content, a representation of the second sub-content item, and a second selectable option that is selectable to add the second sub-content item to the library of the user of the first electronic device.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted device (HMD), a display, a projector, a touch-sensitive display, or other device or component that presents visual content to a user, for example, on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

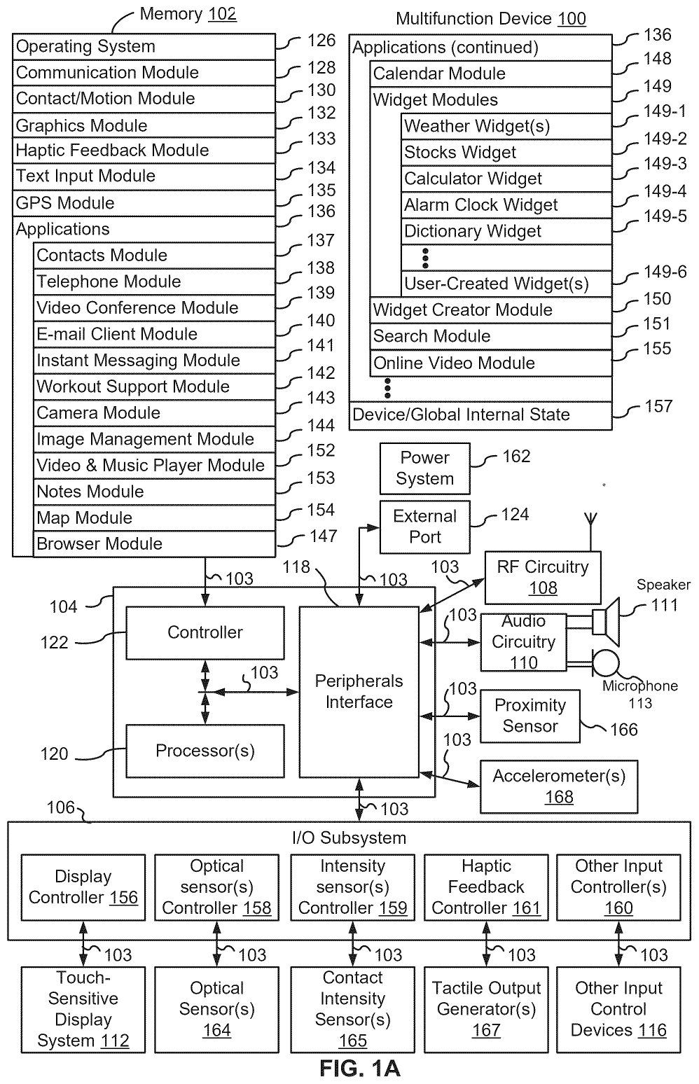

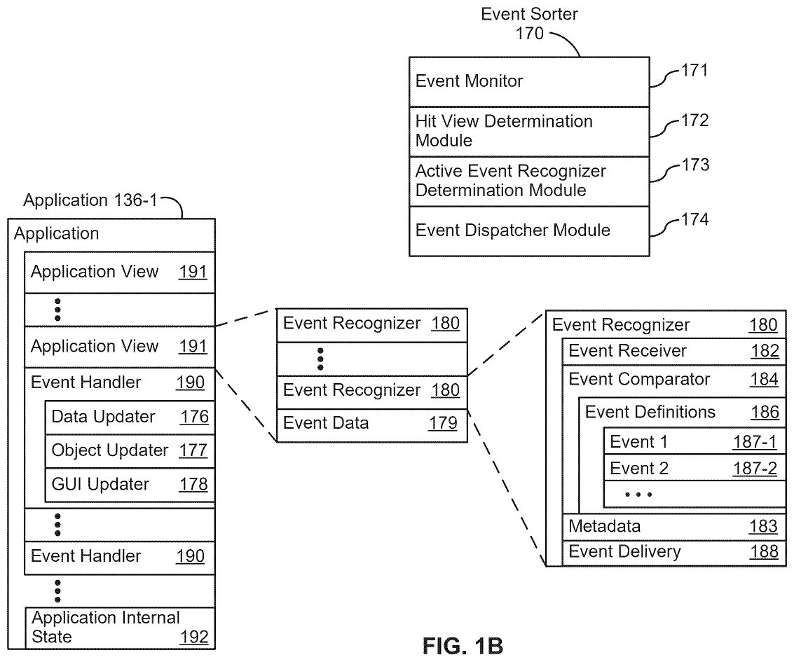

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

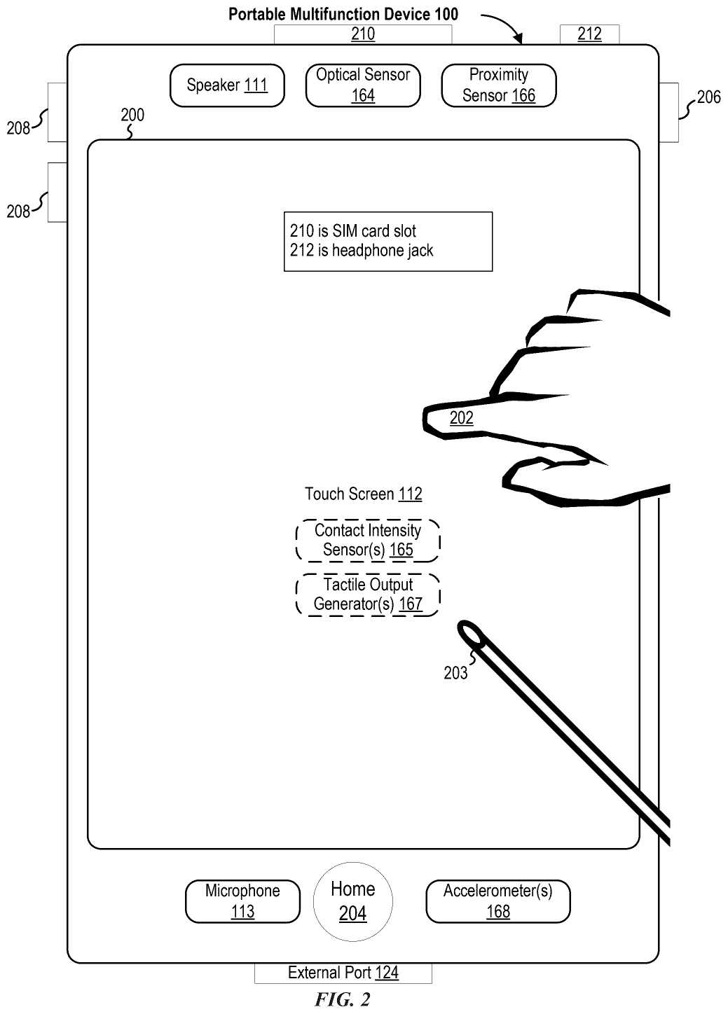

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. Patent application Ser. No. 11/48,264, “Gestures For Touch Sensitive Input Devices,” filed Jan. 31, 2005; (5) U.S. Patent application Ser. No. 11/38,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

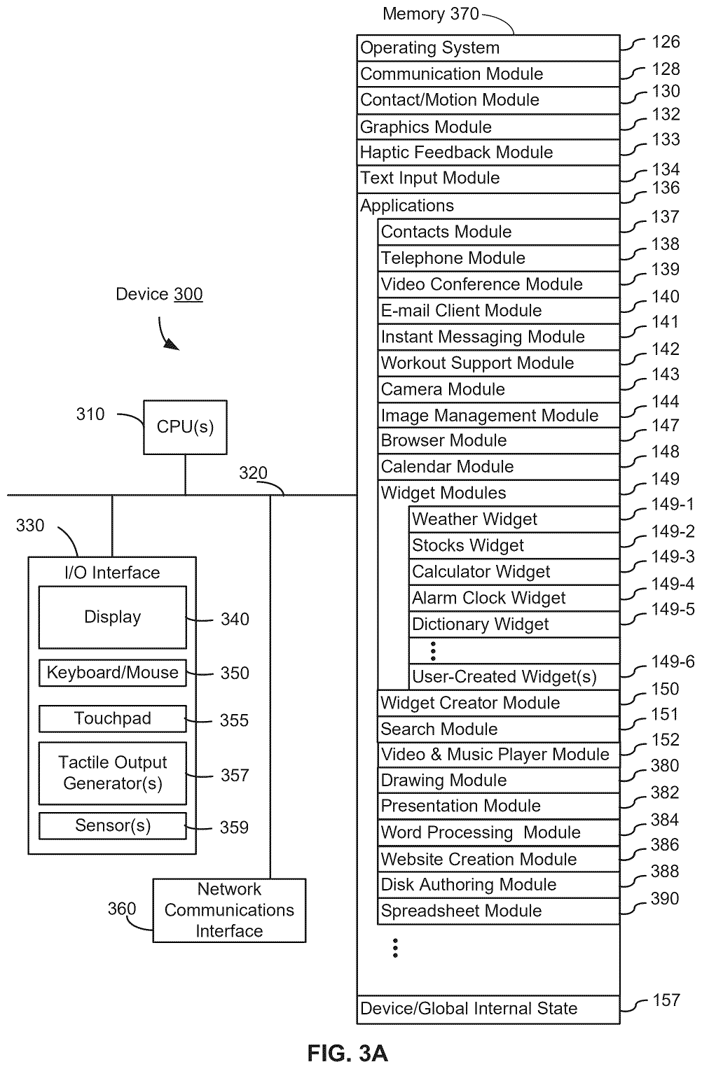

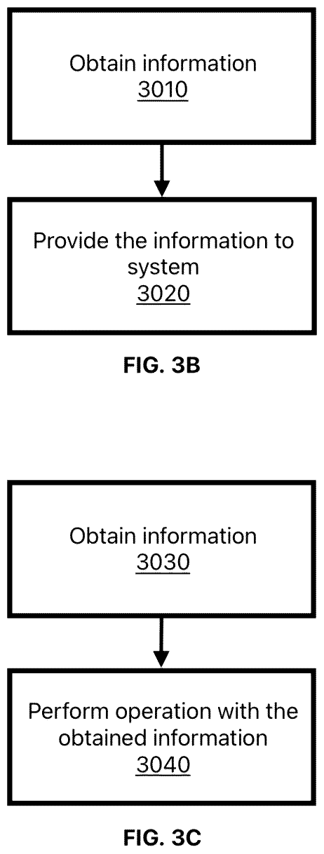

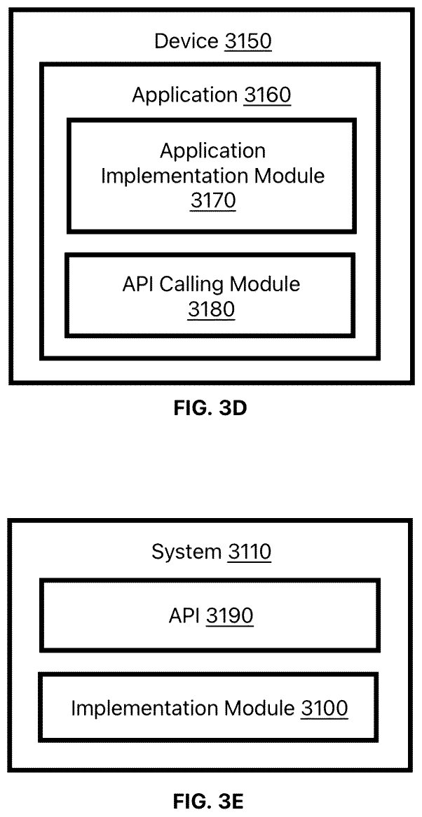

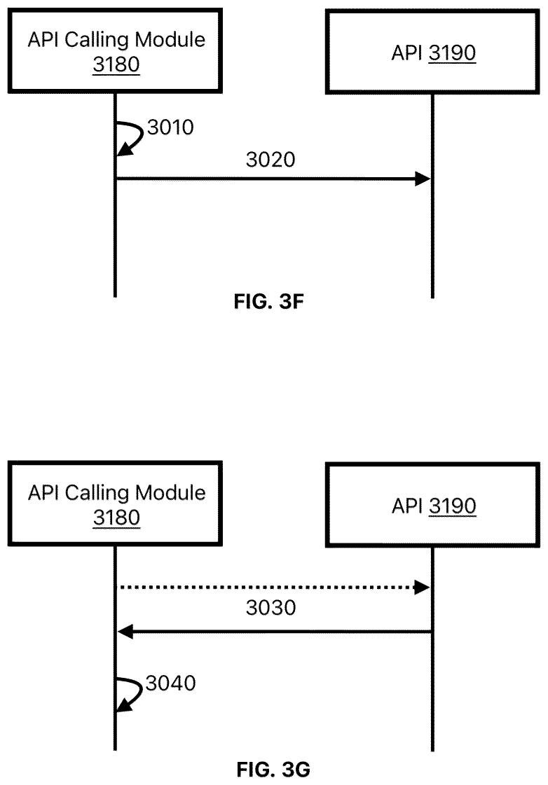

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. Patent application Ser. No. 11/968,67, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In other embodiments, application 3160 is an application that is provided to device 3150 via an operating system update file (e.g., a first party application or a second party application). In other embodiments, application 3160 is an application that is provided via an application store. In some embodiments, the application store can be an application store that is pre-installed on device 3150 at purchase (e.g., a first party application store). In other embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of the device 3150. In some embodiments, at 3010, information is obtained from at least one software module of the device 3150. In some embodiments, at 3010, information is obtained from at least one hardware component external to the device 3150 (e.g., a peripheral device, an accessory device, a server, etc.). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on the device 3150. In some embodiments, the system (e.g., 3110 shown in FIG. 3E) is an external device (e.g., a server, a peripheral device, an accessory, a personal computing device, etc.) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and operating system (e.g., system 3110 shown in FIG. 3E). Application 3160 includes application implementation module 3170 and API calling module 3180. System 3110 includes API 3190 and implementation module 3100. It should be recognized that device 3150, application 3160, and/or system 3110 can include more, fewer, and/or different components than illustrated in FIGS. 3D and 31E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API calling module to communicate with system 3110 via API 3190 (shown in FIG. 3E).

In some embodiments, API 3190 is a software module (e.g., a collection of computer-readable instructions) that provides an interface that allows a different module (e.g., API calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In other embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is an system (e.g., operating system, server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or other hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus be both an API calling module and an implementation module. It should be recognized that implementation module 3100 can include additional functions, methods, classes, data structures, and/or other features that are not specified through API 3190 and are not available to API calling module 3180. It should also be recognized that API calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected the direct sensor data is frequently processes into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

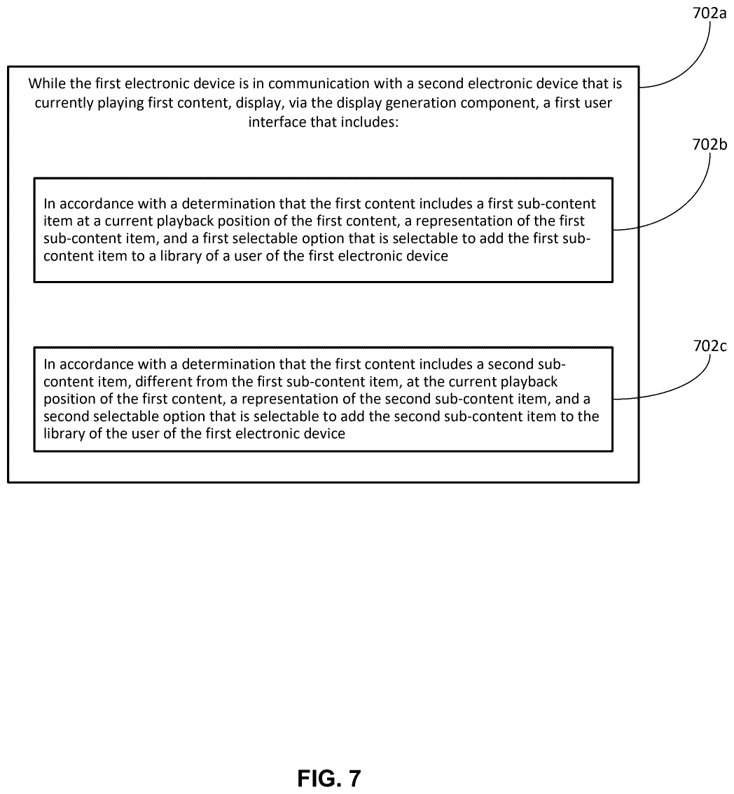

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 3190 defines a first API call that can be provided by API calling module 3190. The implementation module is an system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

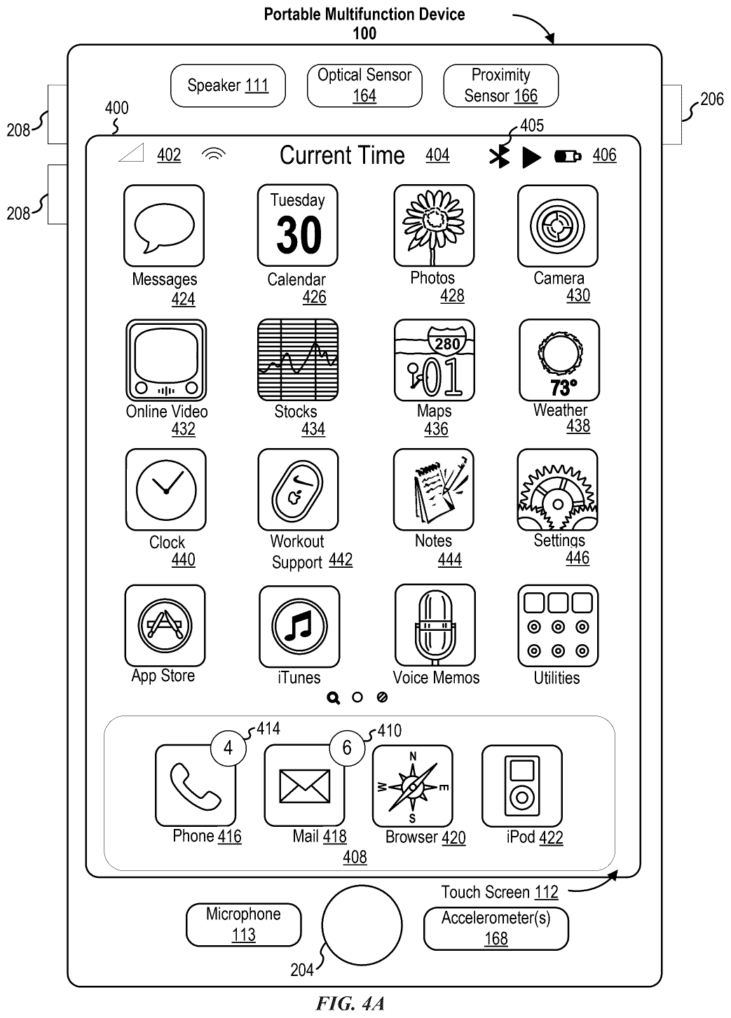

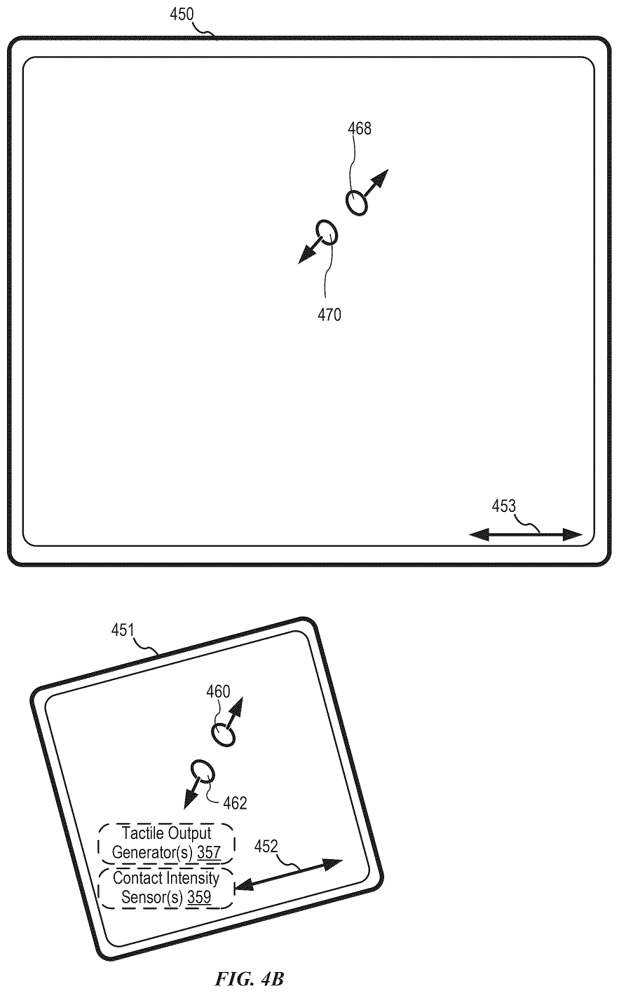

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

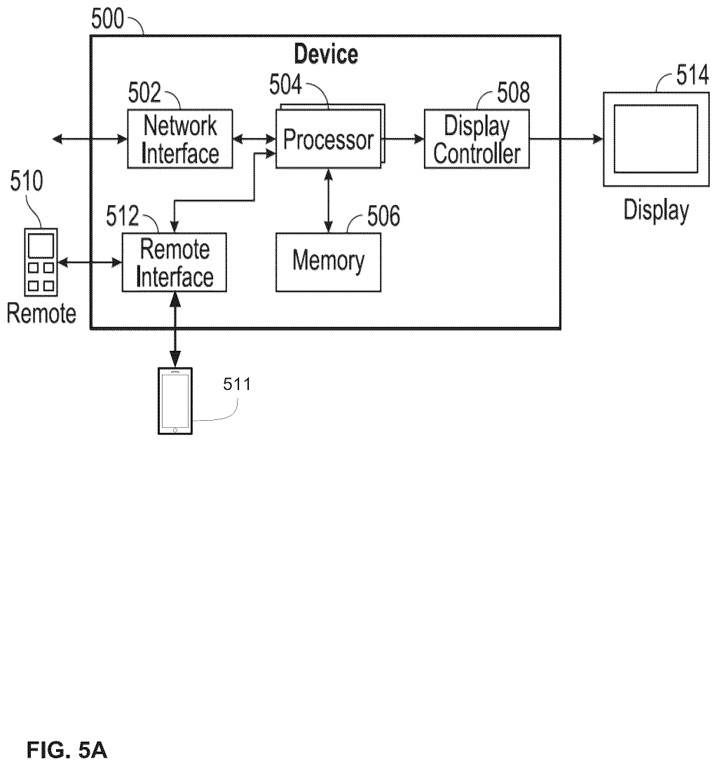

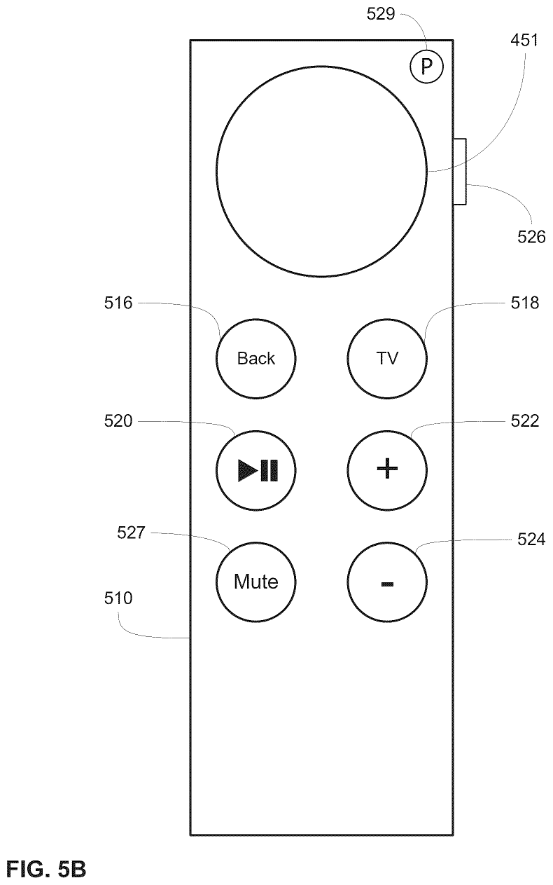

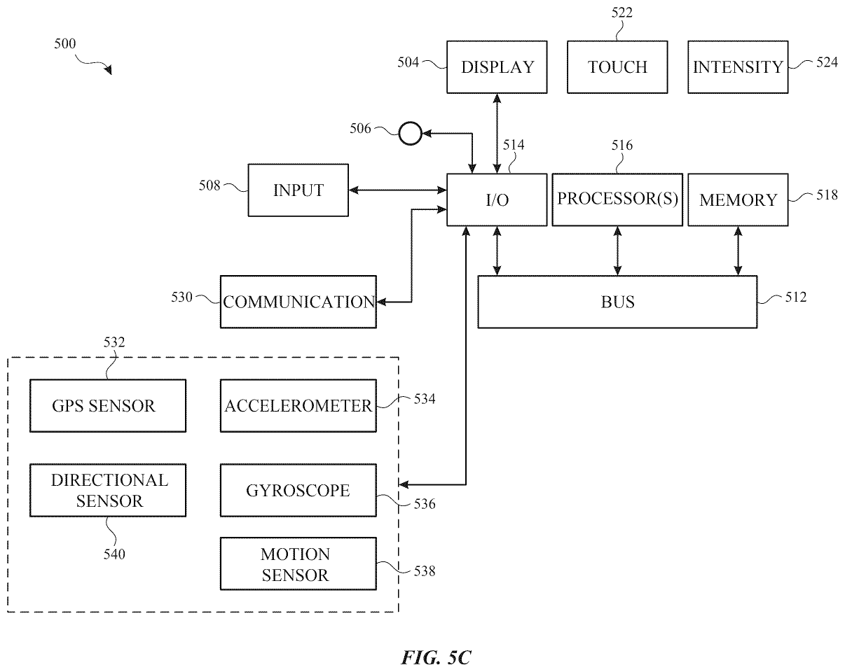

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 504 optionally execute any number of programs stored in memory 506 or storage, which optionally includes instructions to perform one or more of the methods and/or processes described herein (e.g., method 700).

In some embodiments, display controller 508 causes the various user interfaces of the disclosure to be displayed on display 514. Further, input to device 500 is optionally provided by remote 510 via remote interface 512, which is optionally a wireless or a wired connection. In some embodiments, input to device 500 is provided by a multifunction device 511 (e.g., a smartphone) on which a remote control application is running that configures the multifunction device to simulate remote control functionality, as will be described in more detail below. In some embodiments, multifunction device 511 corresponds to one or more of device 100 in FIGS. 1A and 2, and device 300 in FIG. 3. It is understood that the embodiment of FIG. 5A is not meant to limit the features of the device of the disclosure, and that other components to facilitate other features described in the disclosure are optionally included in the architecture of FIG. 5A as well. In some embodiments, device 500 optionally corresponds to one or more of multifunction device 100 in FIGS. 1A and 2 and device 300 in FIG. 3; network interface 502 optionally corresponds to one or more of RF circuitry 108, external port 124, and peripherals interface 118 in FIGS. 1A and 2, and network communications interface 360 in FIG. 3; processor 504 optionally corresponds to one or more of processor(s) 120 in FIG. 1A and CPU(s) 310 in FIG. 3; display controller 508 optionally corresponds to one or more of display controller 156 in FIG. 1A and I/O interface 330 in FIG. 3; memory 506 optionally corresponds to one or more of memory 102 in FIG. 1A and memory 370 in FIG. 3; remote interface 512 optionally corresponds to one or more of peripherals interface 118, and I/O subsystem 106 (and/or its components) in FIG. 1A, and I/O interface 330 in FIG. 3; remote 512 optionally corresponds to and or includes one or more of speaker 111, touch-sensitive display system 112, microphone 113, optical sensor(s) 164, contact intensity sensor(s) 165, tactile output generator(s) 167, other input control devices 116, accelerometer(s) 168, proximity sensor 166, and I/O subsystem 106 in FIG. 1A, and keyboard/mouse 350, touchpad 355, tactile output generator(s) 357, and contact intensity sensor(s) 359 in FIG. 3, and touch-sensitive surface 451 in FIG. 4B; and, display 514 optionally corresponds to one or more of touch-sensitive display system 112 in FIGS. 1A and 2, and display 340 in FIG. 3.

FIG. 5B illustrates an exemplary structure for remote 510 according to some embodiments of the disclosure. In some embodiments, remote 510 optionally corresponds to one or more of multifunction device 100 in FIGS. 1A and 2 and device 300 in FIG. 3. Remote 510 optionally includes touch-sensitive surface 451. Touch-sensitive surface 451 is optionally able to sense contacts as well as contact intensities (e.g., clicks of touch-sensitive surface 451), as previously described in this disclosure. Further, touch-sensitive surface 451 optionally includes a mechanical actuator for providing physical button click functionality (e.g., touch-sensitive surface 451 is “clickable” to provide corresponding input to device 500). Remote 510 also optionally includes buttons 516, 518, 520, 522, 524, 526, 527 and 529. Buttons 516, 518, 520, 522, 524, 526, 527 and 529 are optionally mechanical buttons or mechanical button alternatives that are able to sense contact with, or depression of, such buttons to initiate corresponding action(s) on, for example, device 500. In some embodiments, selection of “back” button 516 by a user navigates device 500 backwards in a currently-executing application or currently-displayed user interface (e.g., back to a user interface that was displayed previous to the currently-displayed user interface), or navigates device 500 to a one-higher-level user interface than the currently-displayed user interface. In some embodiments, selection of “TV” button 518 by a user navigates device 500 to a main, home, media browsing user interface or root user interface from any user interface that is displayed on device 500 (e.g., to a home screen of device 500 that optionally includes one or more applications accessible on device 500 or to a media browsing user interface of device 500 that includes representations of media available for viewing via device 500). In some embodiments, selection of the “TV” button 518 causes the electronic device to navigate to a unified media browsing application. In some embodiments, selection of “play/pause” button 520 by a user toggles between playing and pausing a currently-playing content item on device 500 (e.g., if a content item is playing on device 500 when “play/pause” button 520 is selected, the content item is optionally paused, and if a content item is paused on device 500 when “play/pause” button 520 is selected, the content item is optionally played). In some embodiments, selection of “+” 522 or “−” 524 buttons by a user increases or decreases, respectively, the volume of audio reproduced by device 500 (e.g., the volume of a content item currently-playing on device 500). In some embodiments, selection of “audio input” button 526 (e.g., which is optionally a button on the side surface of remote 510, rather than on the surface of remote 510 that includes buttons 516, 518, 520, 522, 524 and 527) by a user allows the user to provide audio input (e.g., voice input) to device 500, optionally, to a voice assistant on the device. In some embodiments, remote 510 includes a microphone via which the user provides audio input to device 500 upon selection of “audio input” button 526. In some embodiments, remote 510 includes one or more accelerometers for detecting information about the motion of the remote. In some embodiments, selection of “Mute” button 527 toggles the audio reproduced by device 500 on and off. In some embodiments, selection of “Power” button 529 causes device 500 (and/or external devices coupled to device 500, such as display 514) to toggle between entering or exiting a low or off power state.

FIG. 5C depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes described with reference to FIGS. 7 and 9. A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5C, but can include other or additional components in multiple configurations.

In some embodiments, electronic device 500 includes one or more tactile output generators, where the one or more tactile output generators generate different types of tactile output sequences, as described below in Table 1. In some embodiments, a particular type of tactile output sequence generated by the one or more tactile output generators of the device corresponds to a particular tactile output pattern. For example, a tactile output pattern specifies characteristics of a tactile output, such as the amplitude of the tactile output, the shape of a movement waveform of the tactile output, the frequency of the tactile output, and/or the duration of the tactile output. When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

One or more of the embodiments disclosed herein optionally include one or more of the features disclosed in the following patent applications: “User Interfaces For Interacting with Channels that Provide Content that Plays in a Media Browsing Application” (Attorney Docket No.: 106843171600 (P42089USP1), filed Mar. 24, 2019), “User Interfaces For a Media Browsing Application” (Attorney Docket No.: 106843171700 (P42090USP1), filed Mar. 24, 2019), and “User Interface Specific to Respective Content Items” (Attorney Docket No.: 106843171900 (P42092USP1), filed Mar. 24, 2019), each of which is hereby incorporated by reference.

Attention is now directed towards embodiments of user interfaces (“UI”) and associated processes that are implemented on an electronic device, such as portable multifunction device 100, device 300, or device 500.

### User Interfaces and Associated Processes

### Content User Interfaces

Providing efficient ways of performing operations at a first electronic device in connection with operations being performed at a second electronic device enhances, and makes more efficient, user interactions with the first electronic device and/or the second electronic device—which reduces the computing resources needed by the first electronic device and/or the second electronic device. In some embodiments, while the first electronic device is in communication with a second electronic device that is currently playing first content, the first electronic device displays, via a display generation component, a first user interface that includes, in accordance with a determination that the first content includes a first sub-content item at a current playback position of the first content: a representation of the first sub-content item, and a first selectable option that is selectable to add the first sub-content item to a library of a user of the first electronic device. In some embodiments, while the first electronic device is in communication with the second electronic device that is currently playing the first content, the first electronic device displays, via the display generation component, the first user interface that includes, in accordance with a determination that the first content includes a second sub-content item, different from the first sub-content item, at the current playback position of the first content, a representation of the second sub-content item, and a second selectable option that is selectable to add the second sub-content item to the library of the user of the first electronic device. Enhancing the interactions between the user and the first electronic device reduces the amount of time needed by a user and/or the device to respond to user inputs, and thus reduces the power usage of the device and increases battery life for battery-powered devices. It is understood that people use devices. When a person uses a device, that person is optionally referred to as a user of the device.

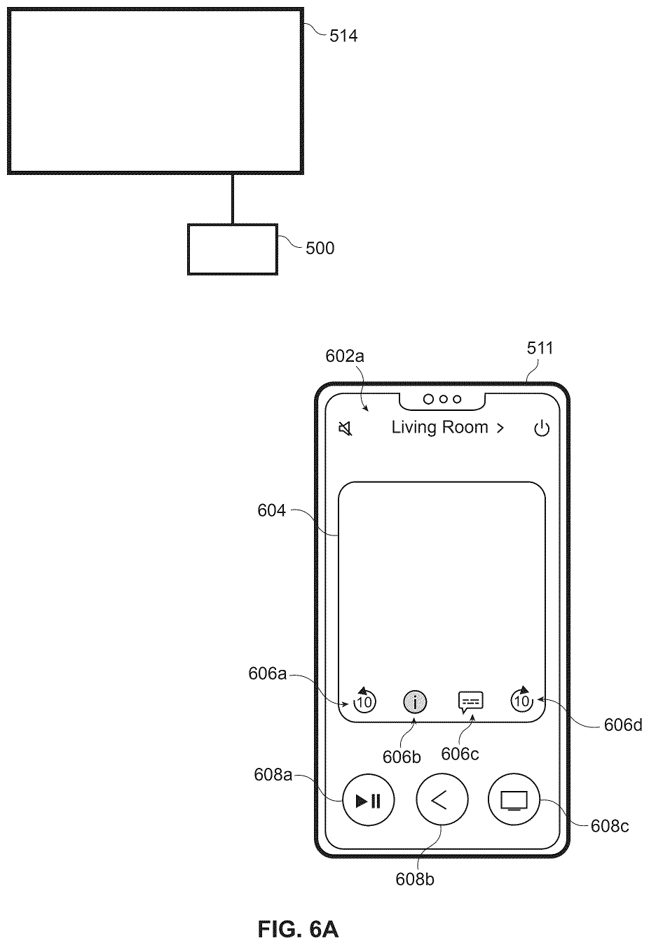

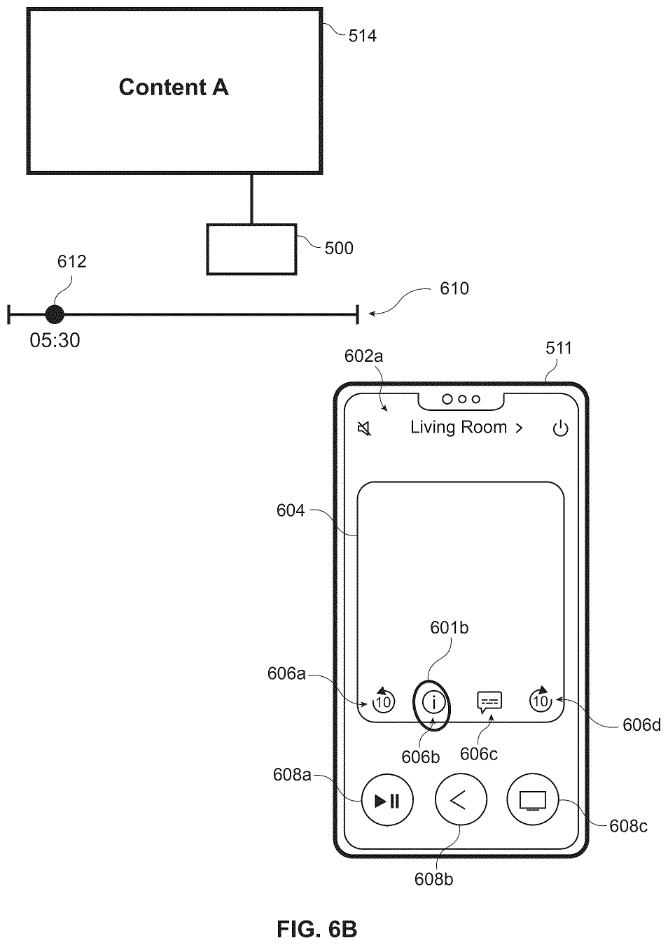

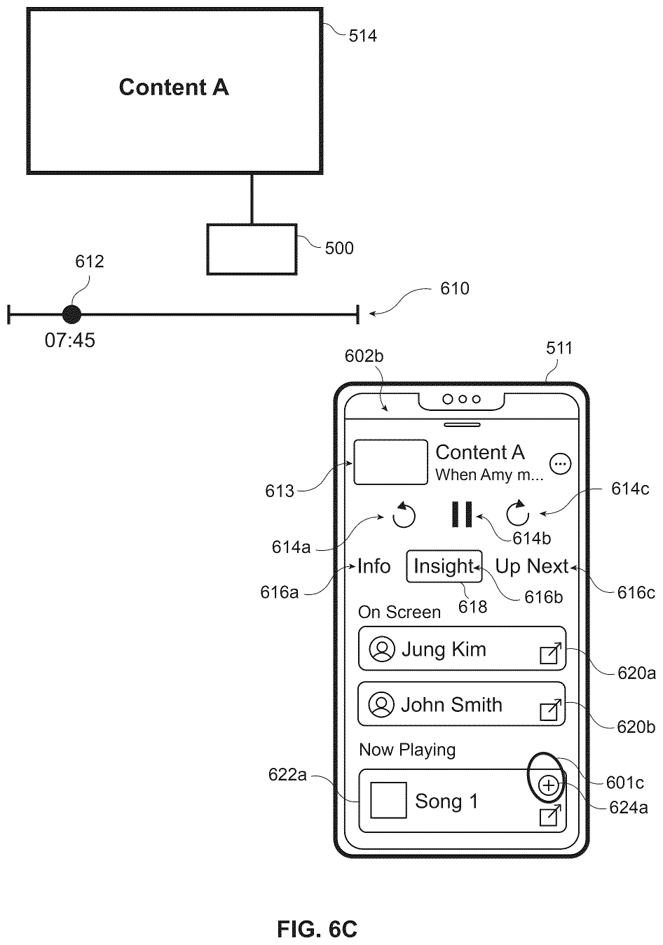

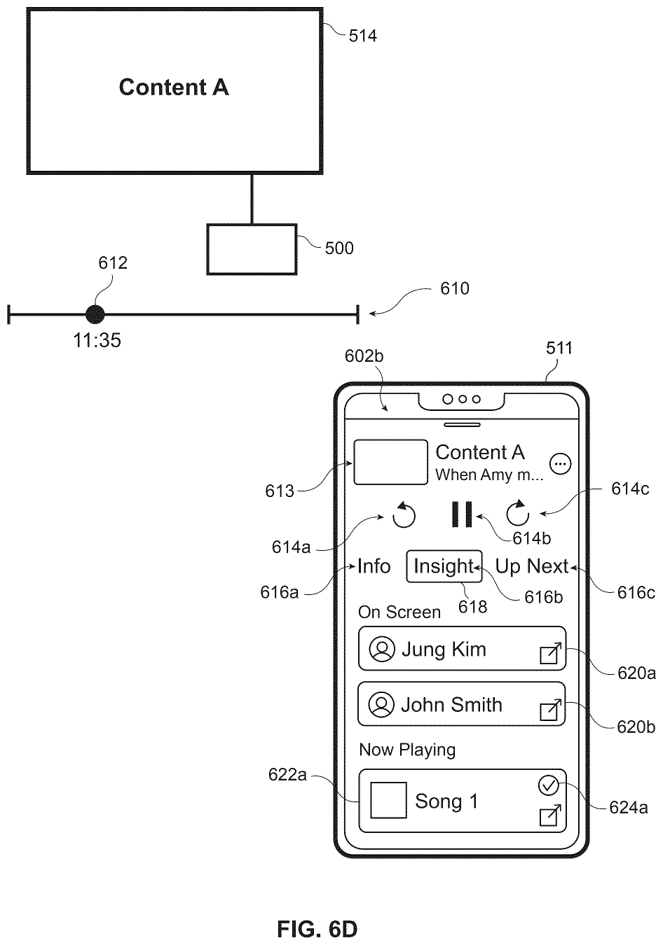

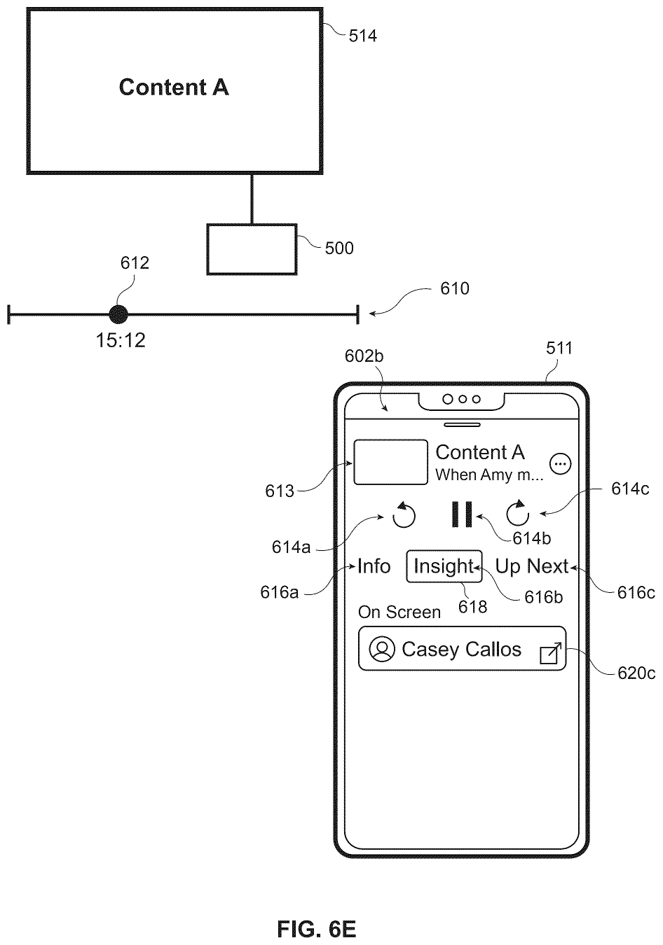

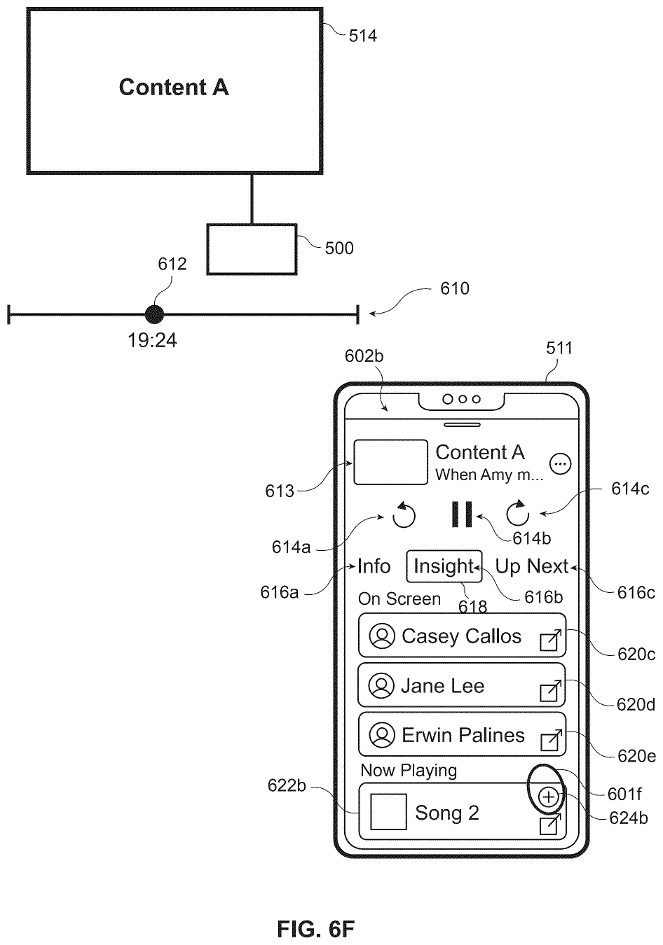

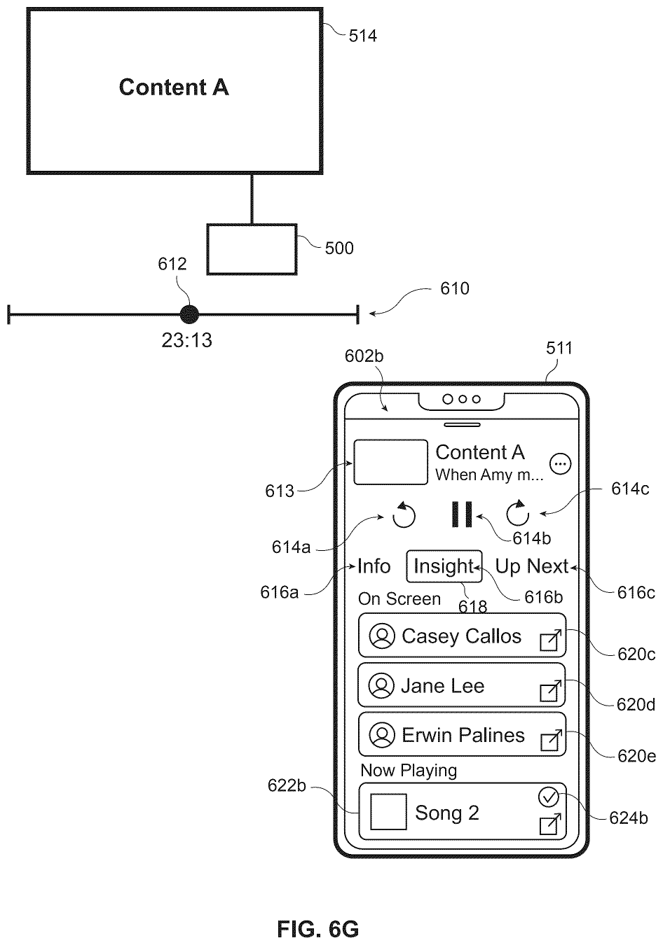

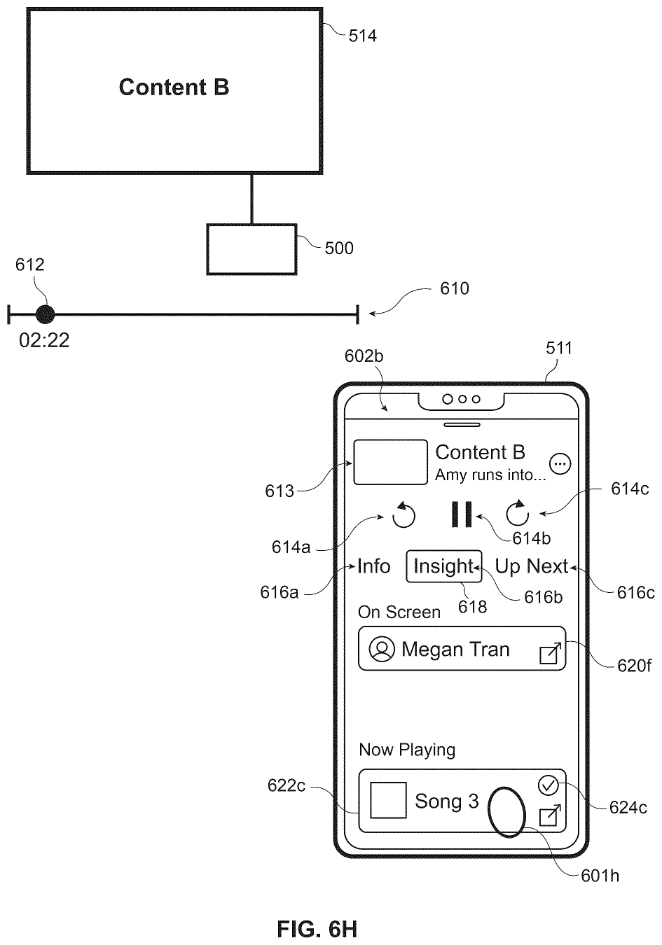

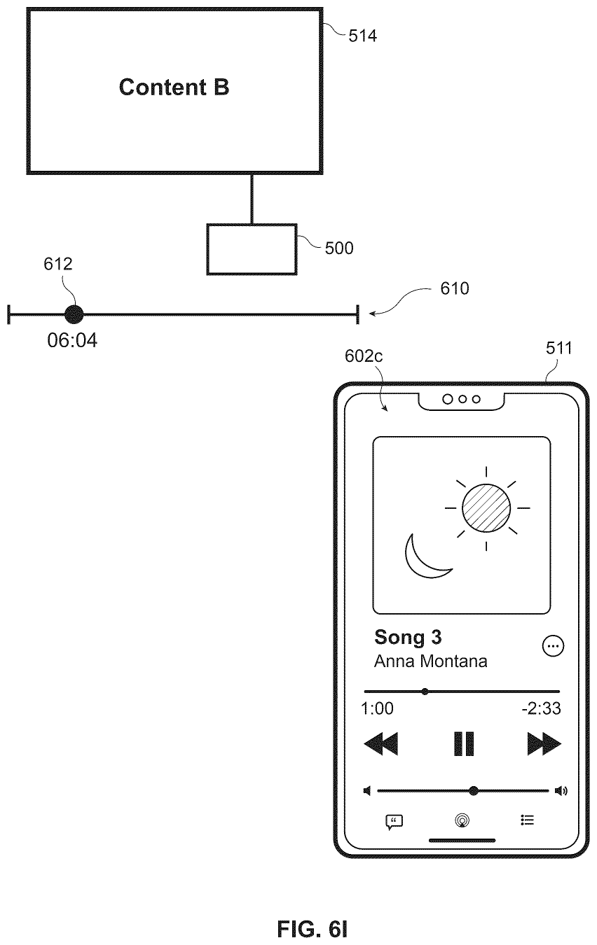

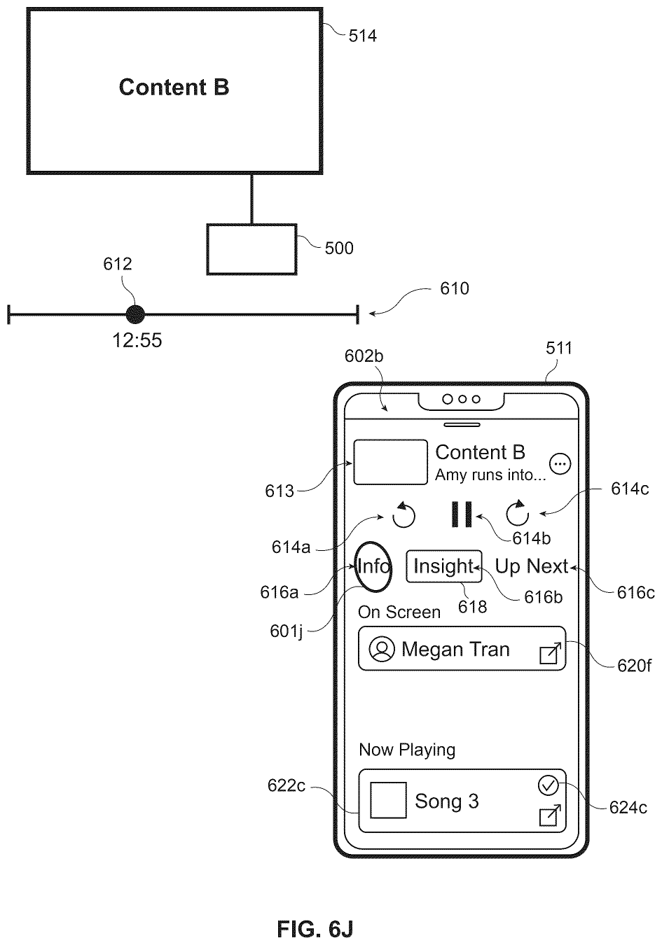

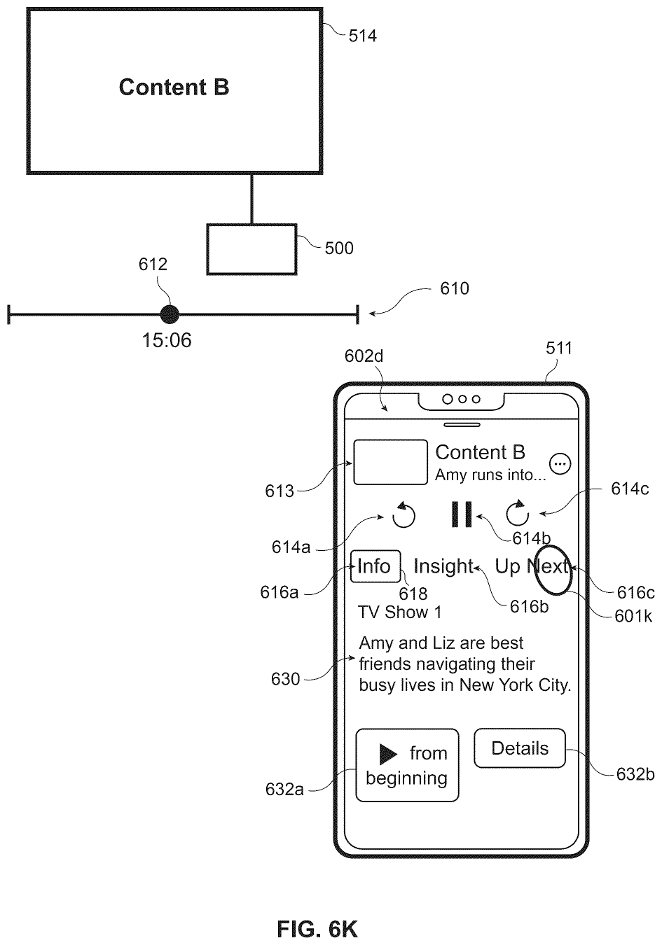

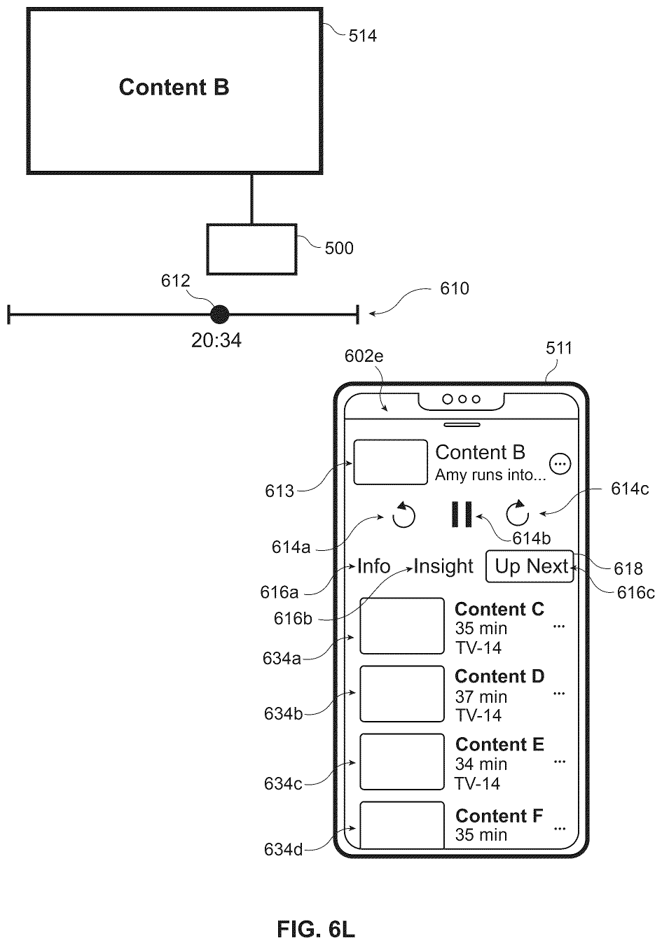

FIGS. 6A-6L illustrate exemplary ways in which a first electronic device displays and/or facilitates interaction with user interfaces displayed by the first electronic device in connection with content being played back at a second electronic device in accordance with some embodiments of the disclosure in accordance with some embodiments of the disclosure. The embodiments in these figures are used to illustrate the processes described below, including the processes described with reference to FIG. 7.

FIG. 6A illustrates an electronic device 500, in communication with a display 514. It is understood that as described further with reference to method 700, electronic device 500 optionally corresponds to a media set top box or digital media player, in wireless or wired communication with display 514, which optionally corresponds to a television, monitor, and/or a projection device configured to cast images onto a surface in a physical environment of the user of electronic device 500.

In some embodiments, electronic device 500 is in wired or wireless communication with device 511 (e.g., such as described with reference to FIGS. 5A-5C). Device 511 is optionally a multifunction device, such as a smartphone, a smartwatch, a tablet computer or a computer more generally. In some embodiments, device 511 includes a remote control application installed on device 511 (e.g., the application is part of the operating system of device 511, or the application is separate from the operating system of device 511). In some embodiments, the remote control application running on device 511 enables device 511 to control device 500, analogous to a physical remote control controlling device 500.

In FIG. 6A, device 511 is displaying user interface 602a of the remote control application via a touch screen included in device 511. User interface 602a includes a number of control elements for controlling device 500. For example, user interface 602a includes a region 604 that is configured to operate similar to a touch-sensitive surface of a remote control (e.g., responding to tap or swipe inputs within region 604 to cause device 511 to transmit corresponding control commands to device 500, similar to or the same as the commands transmitted by a dedicated remote control in response to the same or similar inputs). In FIG. 6A, user interface 602a includes selectable options 606a-d, and 608a-c. Selectable option 606a is selectable to skip backwards in content that is playing on device 500, selectable option 606b is selected to display information about content that is playing on device 500 (as will be described later), selectable option 606c is selectable to control subtitles displayed by device 500 for content that is playing on device 500, and selectable option 606d is selectable to skip forward in content that is playing on device 500. Selectable option 608a is selectable to play or pause content that is playing on device 500, selectable option 608b is selectable to navigate backwards in a user interface(s) displayed by device 500, and selectable option 608c is selectable to navigate device 500 backwards in a currently-executing application or currently-displayed user interface (e.g., back to a user interface that was displayed previous to the currently-displayed user interface), or navigate device 500 to a one-higher-level user interface than the currently-displayed user interface. The various buttons, regions and/or functionalities in user interface 602a optionally correspond to (e.g., are the same as) the various buttons, regions and/or functionalities of remote 510 described with reference to FIG. 5B.

In FIG. 6A, device 500 is not playing content (e.g., movie, television show, music, podcast, video, or the like). Therefore, selectable option 606b is deactivated (e.g., does not respond to selection inputs directed to it) and is displayed with a deemphasized visual appearance (e.g., greyed out, darker, with less color, with less brightness, or the like).

In FIG. 6B, device 500 has started playing Content A, and displaying Content A via display 514. Progress bar 610 optionally indicates the playback progress of device 500 through Content A. In FIG. 6B, device 500 is five minutes, thirty seconds into Content A, as indicated by current playback position indicator 612. Throughout the figures, the state of current playback position indicator 612 within progress bar 610 is illustrated to be accurate, such that progression/movement of current playback position indicator 612 (and illustration of current playback position indicator 612 with different indications of time) convey that playback through Content A (or another content item being played by device 500) has progressed (or regressed). In FIG. 6B, because device 500 is playing content, device 511 updates the visual appearance of selectable option 606b to no longer be visually deemphasized (e.g., displayed with more color, more brightness, no longer greyed out, or the like), and activates selectable option 606b (e.g., selectable option 606b responds to selection inputs directed to it). In FIG. 6B, device 511 detects selection of selectable option 606b (e.g., via a tap of contact 601b).

In response, in FIG. 6C, device 511 displays user interface 602b of the remote control application on device 511. In some embodiments, user interface 602b is overlaid on user interface 602a; in some embodiments, device 511 ceases display of user interface 602a. User interface 602b includes an information section 613, which includes information about the content playing on device 500. For example, section 613 includes an image corresponding to Content A, the title of Content A, or other information relevant to Content A. User interface 602b also includes playback controls 614a, 614b, and 614c. Control 614a is selectable to skip backward in Content A on device 500, control 614b is selectable to play or pause Content A on device 500, and control 614c is selectable to skip forward in Content A on device 500.

User interface 602b in FIG. 6C further includes navigation elements 616a, 616b and 616c that are selectable to navigate to different user interfaces of the remote control application on device 511. Navigation element 616a is selectable to display further information about Content A, navigation element 616b is selectable to display information about actors and/or songs that are in Content A at the current playback position in Content A, and navigation element 616c is selectable to display information about a content playback queue, which includes Content A, that device 500 is currently playing through.

In FIG. 6C, navigation element 616b has the current focus (e.g., is currently selected) as indicated by current focus indicator 618. As a result, device 511 is displaying user interface 602b, which also includes representations 620a and 620b of actors that are in Content A at the current playback position in Content A. For example, representation 620a corresponds to actor Jung Kim, and includes an image of Jung Kim, and the name of Jung Kim. Representation 620a is optionally selectable to cause device 511 to display a user interface with further information about Jung Kim, as described further with reference to method 700. Representation 620b corresponds to actor John Smith, and includes an image of John Smith, and the name of John Smith.

Representation 620b is optionally selectable to cause device 511 to display a user interface with further information about John Smith, as described further with reference to method 700. User interface 602b optionally includes representations 620a and 620b, because Content A at its current playback position optionally includes both actors corresponding to representations 620a and 620b.

In FIG. 6C, Content at A the current playback position also includes a song (e.g., a sub-content item that is part of the audio track of Content A). As a result, device 511 is displaying, in user interface 602b, representation 622a corresponding to the song that is included in the current playback position in Content A (e.g., Song 1). Representation 622a corresponds to Song 1, and includes an image of Song 1, and the name of Song 1. Representation 622a is optionally selectable to cause device 511 to display a user interface with further information about Song 1, as described further with reference to method 700. Further, representation 622a includes selectable option 624a that is selectable to cause device 511 to add Song 1 to a library of the user of device 511, while maintaining display of user interface 602b on device 511 and playback of Content A on device 500. In FIG. 6C, selectable option 624a has a visual appearance corresponding to an unselected state (e.g., indicating that Song 1 is not in the library of the user of device 511).

In FIG. 6C, device 511 detects selection of selectable option 624a (e.g., via a tap of contact 601c). In response, in FIG. 6D, device 511 has added Song 1 to the library of the user of device 511, and also updates the visual appearance of selectable option 624a to that of a selected state (e.g., indicating that Song 1 is in the library of the user of device 511). In some embodiments, the visual appearance of selectable option 624a in the unselected state is different from the visual appearance of selectable option 624a in the selected state.

In FIG. 6E, playback of Content A on device 500 has progressed, as indicated by progress bar 610 and current playback position indicator 612. At the current playback position in FIG. 6E, Content A no longer includes Jung Kim, John Smith, or Song 1. Therefore, device 511 has updated display of user interface 602b to no longer include the representations corresponding to Jung Kim, John Smith, or Song 1. However, in FIG. 6E, Content A at its current playback position includes actor Casey Callos. Therefore, device 511 has updated display of user interface 602b to include representation 620c corresponding to Casey Callos (and optionally having one or more of the characteristics of representations 620a and 620b).

In FIG. 6F, playback of Content A on device 500 has progressed, as indicated by progress bar 610 and current playback position indicator 612. At the current playback position in FIG. 6F, Content A still includes actor Casey Callos, and also includes actors Jane Lee and Erwin Palines. Therefore, device 511 has updated display of user interface 602b to continue to include representation 620c, and also include representation 620d corresponding to Jane Lee (and optionally having one or more of the characteristics of representations 620a and 620b), and representation 620e corresponding to Erwin Palines (and optionally having one or more of the characteristics of representations 620a and 620b). In FIG. 6F, Content A at its current playback position also includes Song 2. Therefore, device 511 has updated display of user interface 602b to include representation 622b corresponding to Song 2 (and optionally having one or more of the characteristics of representations 622a). In FIG. 6F, device 511 detects selection of selectable option 624b, and in response, in FIG. 6G, device 511 has added Song 2 to the library of the user of device 511, and has updated the visual appearance of selectable option 624b to indicate that Song 2 is now in the library of the user of device 511, analogous to as described previously with reference to selectable option 624a.

In FIG. 6H, device 500 has completed playback of Content A, and has switched to playing Content B (e.g., because Content B was after Content A in the content playback queue of device 500). Therefore, progress bar 610 indicates that the current playback position in Content B is towards the beginning of Content B (e.g., as shown by current playback position indicator 612). At the current playback position in FIG. 6H, Content B includes actor Megan Tran, and also includes Song 3. Therefore, device 511 has updated display of user interface 602b to include representation 620f corresponding to Megan Tran (and optionally having one or more of the characteristics of representations 620a and 620b), and representation 622c corresponding to Song 3 (and optionally having one or more of the characteristics of representations 622a). In FIG. 6H, Song 3 was already in the library of the user of device 511 when device 511 displayed representation 622c in user interface 602b; therefore, selectable option 624c is already displayed with the visual appearance indicating that Song 3 is in the library of the user of device 511. In some embodiments, when a song (or other content item) is in the library of the user of device 511, the selectable option 624a, 624b and/or 624c is selectable to remove the song (or other content item) from the library of the user of device 511.

In FIG. 6H, device 511 detects selection of representation 622c (e.g., via a tap of contact 601h), outside of selectable option 624c. In response, in FIG. 6I, device 511 displays user interface 602c (e.g., an ceases displaying user interface 602b). User interface 602c is optionally a user interface of a content application on device 511 via which content (e.g., music, songs, music videos, or the like-more generally, content of the same type as the type of content of the sub-content item(s) included in Content A and/or Content B and/or other content playing on device 500) is accessible on device 511. The content application is optionally a different application than the remote control application on device 511. Device 511 is displaying a user interface corresponding to Song 3 in the content application in response to the input in FIG. 6H. For example, user interface 602c corresponds to Song 3, and includes artwork corresponding to Song 3, the title/artist for Song 3, playback controls for controlling playback of Song 3 on device 511 and/or volume controls for controlling a volume of playback of Song 3 on device 511. In some embodiments, in response to the input in FIG. 6H, device 511 does not automatically start playing Song 3 on device 511, and further input (e.g., via user interface 602c) is required to initiate playback of Song 3 on device 511; in some embodiments, in response to the input in FIG. 6H, device 511 does automatically start playing Song 3 on device 511. If device 511 had instead detected selection of a representation of a different song (e.g., Song 1 or Song 2), device 511 would have optionally ceased displaying user interface 602b, and displayed a different user interface of the content application corresponding to the selected song instead (e.g., having analogous components to those of user interface 602c).

In FIG. 6J, device 511 is displaying user interface 602b again while Content B is playing on device 500. User interface 602b has one or more of the characteristics of user interface 602b in FIG. 6H. In FIG. 6J, device 511 detects selection of navigation element 616a (e.g., via a tap of contact 601j). In response, as shown in FIG. 6K, device 511 displays movement of the current focus indicator 618 away from navigation element 616b and to navigation element 616a, ceases displaying representations 620f and 622c, and displays information about Content B that is playing on device 500 (e.g., in user interface 602d). User interface 602d optionally maintains the same content (e.g., controls, information, etc.) displayed above navigation elements 616a, 616b and 616c as were included in user interface 602b. Further, device 500 optionally continues playback of Content B in response to the input detected in FIG. 6J.

In FIG. 6K, user interface 602d includes textual information 630 corresponding to Content B that is playing on device 500 (e.g., title of the content, and a summary of the content), a selectable option 632a to restart playback of Content B on device 500, and a selectable option 632b to display further information about Content B that is playing on device 500 (e.g., to display, on device 511, information about actors, parental rating, duration, video format, audio format, etc. of Content B). In FIG. 6K, device 511 detects selection of navigation element 616c (e.g., via a tap of contact 601k). In response, as shown in FIG. 6L, device 511 displays movement of the current focus indicator 618 away from navigation element 616a and to navigation element 616c, ceases displaying information 630 and selectable options 632a and 632b, and displays information about a content queue that device 500 is playing through (e.g., in user interface 602e). User interface 602e optionally maintains the same content (e.g., controls, information, etc.) displayed above navigation elements 616a, 616b and 616c as were included in user interface 602b. Further, device 500 optionally continues playback of Content B in response to the input detected in FIG. 6K.

In FIG. 6L, user interface 602e includes information about a content queue that is in effect at device 500. For example, user interface 602e includes information about the content items (e.g., movies, television shows, etc.) that are next up in the queue of content items that includes Content A and/or Content B. For example, in FIG. 6I, user interface 602e includes representations 634a-d, corresponding to the content items that are next up in the content queue, and displayed in the order in which the content items are in the content queue. Representation 634a corresponds to Content C (e.g., after Content B in the content queue), and includes an image corresponding to Content C, the title of Content C, the duration of content C, the parental rating of Content C, and a selectable option (“ . . . ” option) that is selectable to perform one or more operations with respect to Content C (e.g., to reorder Content C in the content queue, to remove Content C from the content queue, to immediately start playback of Content C on device 500, to display further information about Content C on device 511, etc.). Representation 634b corresponds to Content D (e.g., after Content C in the content queue), and includes analogous information and selectable option(s) as representation 634a, but with respect to Content D. Representation 634c corresponds to Content E (e.g., after Content D in the content queue), and includes analogous information and selectable option(s) as representation 634a, but with respect to Content E. Representation 634d corresponds to Content F (e.g., after Content E in the content queue), and includes analogous information and selectable option(s) as representation 634a, but with respect to Content F. Representations 634a-d are optionally vertically scrollable (e.g., upward, via an upward swipe of a contact detected over representations 634a-d), to reveal additional representations of additional content items that are in the content playback queue.

FIG. 7 is a flow diagram illustrating a method of displaying and/or facilitating interaction with user interfaces displayed by a first electronic device in connection with content being played back at a second electronic device in accordance with some embodiments of the disclosure. The method 700 is optionally performed at an electronic device such as device 100, device 300, device 500 or device 511 as described above with reference to FIGS. 1A-1B, 2-3, 4A-4B and 5A-5C. Some operations in method 700 are, optionally combined and/or order of some operations is, optionally, changed.

As described below, the method 700 provides ways to facilitate efficient display and/or interaction with user interfaces displayed by a first electronic device in connection with content being played back at a second electronic device. For battery-operated electronic devices, increasing the efficiency of generating an algorithmic screensaver conserves power and increases the time between battery charges.

In some embodiments, method 700 is performed at a first electronic device in communication with a display generation component and one or more input devices, such as device 511 in FIG. 6A. For example, a device or mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external). In some embodiments, the display generation component is a display integrated with the first electronic device (optionally a touch screen display), external display such as a monitor, projector, television, or a hardware component (optionally integrated or external) for projecting a user interface or causing a user interface to be visible to one or more users, etc. Examples of input devices include physical buttons, knobs, handles, and/or switches of a vehicle, a touch screen, mouse (e.g., external), trackpad (optionally integrated or external), touchpad (optionally integrated or external), microphone for capturing voice commands or other audio input, remote control device (e.g., external), another electronic device (e.g., mobile device that is separate from the electronic device), a handheld device (e.g., external), a controller (e.g., external), a camera, a depth sensor, an eye tracking device, and/or a motion sensor (e.g., a hand tracking device, a hand motion sensor). In some embodiments, method 700 is performed at or by an automobile (e.g., at an infotainment system of an automobile having or in communication with one or more display generation components and/or input devices). In some embodiments, the first electronic device is device 511 in FIGS. 5A-5B.

In some embodiments, while the first electronic device is in communication with a second electronic device that is currently playing first content (e.g., a movie, a video, a television show, a song, etc.), such as device 500 playing Content A via display 514 in FIG. 6B, the first electronic device displays (702a), via the display generation component, a first user interface, such as user interface 602b in FIG. 6C. In some embodiments, the first electronic device is not currently playing the first content. In some embodiments, the first electronic device and the second electronic device are in communication with each other via wired or wireless communication (e.g., Wi-Fi, Bluetooth, NFC or the like). In some embodiments, the two devices are in communication with each other because they are both connected to the same network (e.g., the same wireless network). In some embodiments, the two devices are in communication with each other because they are both configured with the same user account/profile. In some embodiments, if one or more of the above were not true, the two devices would optionally not be in communication with each other. In some embodiments, the first electronic device is not streaming or otherwise transmitting the first content to the second electronic device to facilitate the second electronic device playing the first content. In some embodiments, the second electronic device is playing the first content independently of any function being performed by the first electronic device (e.g., if the first electronic device were to be fully powered off and/or no longer connected to or in communication with any devices, including the second electronic device, the second electronic device would continue playing the first content). In some embodiments, the second electronic device is device 500 in FIGS. 5A-5B.

In some embodiments, the first user interface includes, in accordance with a determination that the first content includes a first sub-content item (e.g., audio, video and/or a combination of audio and video) at a current playback position of the first content, such as Content A including Song 1 in FIG. 6C, a representation of the first sub-content item, such as representation 622a in FIG. 6C (e.g., an identifier of the first sub-content item, like the title, artist and/or album name and/or an image corresponding to the sub-content item (e.g., song image, album image, or the like), and a first selectable option that is selectable to add the first sub-content item to a library of a user of the first electronic device, such as selectable option 624a in FIG. 6C (702b) (e.g., without ceasing display of the first user interface, and without interrupting playback of the first content at the second electronic device). In some embodiments, playback of the first content at the second device is currently at the current playback position (e.g., a particular point in time in the progression through the first content, such as 31 seconds into the first content, 32 mins and 15 seconds into the first content, or the like). In some embodiments, the first sub-content item is a song or other piece of content that is part of the audio track (or video track) of the currently playing portion of the first content. For example, the first sub-content item is a first song that is being played as background or theme music in the first content, along with the visual or other audio content (e.g., dialogue, sound effects, or the like) of the first content. In some embodiments, in response to detecting selection of the first selectable option, the first electronic device adds the first sub-content item to a content library (e.g., collection of saved, favorited, downloaded and/or purchased content) of a user of the first electronic device. In some embodiments, the first user interface is a user interface of an operating system or first application on the first electronic device, and the library of the user is maintained or tracked by a second application, different from the first application and the operating system, of the first electronic device. In some embodiments, the first electronic device adds the first sub-content item to the library of the user without displaying a user interface of the second application. In some embodiments, the first user interface includes the representation of the first sub-content item and the first selectable option without user input for defining or otherwise identifying the first sub-content item.

In some embodiments, the first user interface includes, in accordance with a determination that the first content includes a second sub-content item (e.g., audio, video and/or a combination of audio and video, such as described above with respect to the first sub-content item), different from the first sub-content item, at the current playback position of the first content, such as content A including Song 2 in FIG. 6F, a representation of the second sub-content item, such as representation 622b in FIG. 6F (e.g., such as described above with respect to the representation of the first sub-content item), and a second selectable option that is selectable to add the second sub-content item to the library of the user of the first electronic device, such as selectable option 624b in FIG. 6F (702c) (e.g., such as described above with respect to the first selectable option). Providing for the adding of a sub-content item of a currently playing content item on a different device to a library of a user reduces the amount of input needed to identify and/or add such content to the library of the user, and avoids errors in adding such content to the library of the user, thereby enhancing user interaction with the first electronic device.

In some embodiments, playing the first content includes the second electronic device displaying visual content included in the first content via a second display generation component in communication with the second electronic device, such as displaying Content A on display 514 in FIG. 6C. In some embodiments, the second display generation component has one or more of the characteristics of the display generation component of the first electronic device.

In some embodiments, the first sub-content item is audio content included in the first content, such as Song 1 being included in Content A in FIG. 6C. In some embodiments, the first content includes audio content (e.g., music, songs, dialogue, an audio track, etc.) and visual (e.g., image, video, etc.) content. In some embodiments, the first sub-content item does not include visual content. Providing for the adding of audio content of a currently playing content item on a different device to a library of a user reduces the amount of input needed to identify and/or add such content to the library of the user, and avoids errors in adding such content to the library of the user, thereby enhancing user interaction with the first electronic device.

In some embodiments, the first user interface is a user interface of a remote control application on the first electronic device, such as user interface 602b in FIG. 6C, wherein the remote control application is for controlling the second electronic device from the first electronic device. In some embodiments, the second electronic device is controllable with a dedicated hardware input device (such as remote control 510 in FIG. 5B). In some embodiments, the first electronic device includes software (e.g., an application, or the operating system of the first electronic device) that displays one or more user interfaces that include control elements for controlling operation of the second electronic device. For example, the remote control application displays a user interface that includes one or more selectable options that are selectable to perform corresponding operations at the second electronic device, such as playing/pausing content on the second electronic device, increasing or decreasing a volume level at the second electronic device, or the like. In some embodiments, the remote control application displays a user interface that includes control elements that correspond to some or all of the control elements of the dedicated hardware input device, as described with reference to remote control 510 in FIG. 5B. In some embodiments, in response to detecting interaction with controls in the remote control application, the first electronic device transmits commands corresponding to the interacted—with controls to the second electronic device (e.g., via the mechanism by which the two devices are in communication), and the second electronic device performs the corresponding operation(s) in response. Providing for the adding of a sub-content item of a currently playing content item on a different device to a library of a user from a remote control application reduces the amount of input needed to identify and/or add such content to the library of the user, especially when the first electronic device is being used to control the second electronic device, and avoids errors in adding such content to the library of the user, thereby enhancing user interaction with the electronic device.

In some embodiments, before displaying the first user interface, and while displaying, via the display generation component, a second user interface of the remote control application, different from the first user interface, wherein the second user interface includes one or more control elements for controlling the second electronic device (e.g., such as the control elements described above), such as user interface 602a in FIG. 6B, the first electronic device receives, via the one or more input devices, a first input including selection of a first selectable option in the second user interface, such as selection of option 606b in FIG. 6B. In some embodiments, the first input includes a touch input on the first selectable option. In some embodiments, the first input includes a mouse click on the first selectable option.

In some embodiments, in response to receiving the first input, the first electronic device displays, via the display generation component, the first user interface, such as shown in FIG. 6C. In some embodiments, the first user interface does not include the control elements described above. In some embodiments, the first electronic device ceases display of the second user interface and/or the control elements in response to receiving the first input. In some embodiments, the first user interface is overlaid on the second user interface (e.g., partially or fully obscuring the second user interface). In some embodiments, while displaying the first user interface, an input detected by the first electronic device to navigate backwards or to close the first user interface causes the first electronic device to cease displaying the first user interface and redisplay (and/or reveal) the second user interface. Separating the control elements from the representation of the sub-content item in the remote control application avoids errors in interacting with the first and second electronic devices (e.g., because actions taken from the first user interface optionally result in operations that occur at the first electronic device, whereas actions taken from the second user interface optionally result in operations that occur at the second electronic device), thereby enhancing user interaction with the electronic devices.

In some embodiments, the current playback position in the first content is a first playback position (e.g., a certain progression through the first content, such as 15 minutes into the first content), the first user interface includes the representation of the first sub-content item and the first selectable option that is selectable to add the first sub-content item to the library of the user of the first electronic device (e.g., in accordance with the determination that the first content includes the first sub-content item (e.g., audio, video and/or a combination of audio and video) at the current playback position of the first content), and the first sub-content item is a content item of a first type (e.g., a song, background music, or the like), such as in FIG. 6C.

In some embodiments, after the current playback position of the first content progresses away from the first playback position to a second playback position (e.g., a certain progression through the first content, such as 25 minutes into the first content), different from the first playback position, such as in FIG. 6D (e.g., in response to user input changing the playback position, or in response to the playback position progressing due to continued playback through the first content at the second electronic device), in accordance with a determination that the first content item includes no sub-content item of the first type at the second playback position, such as Content A not including a sub-content item of the first type at playback position 612 in FIG. 6E (e.g., the first content does not have a currently playing song or music in the audio track of the first content at the second playback position, though the first content optionally continues to include visual content at the second playback position, or audio content other than the first type of audio content such as sound effects, dialogue, or the like), the first electronic device displays, via the display generation component, the first user interface, wherein the first user interface does not include a representation of a sub-content item, and does not include a selectable option that is selectable to add a sub-content item to the library of the user of the first electronic device, such as shown with user interface 602b in FIG. 6E. Thus, in some embodiments, if the first content at the current playback position no longer includes a type of audio content (e.g., music, podcast, or the like) that can be added to a library of the user via a content application (e.g., a music application on the first electronic device), the first electronic device optionally does not display any representations of sub-content items in the first user interface (and thus does not display corresponding selectable options for adding those sub-content items to the library of the user). In some embodiments, if the first content at the second playback position continued to include the first sub-content item of the first type, the first electronic device would continue to display, in the first user interface, the representation of the first sub-content item and the first selectable option that is selectable to add the first sub-content item to the library of the user of the first electronic device (e.g., continues to display them until the first content item no longer includes the first sub-content item of the first type). Forgoing display of a representation of a sub-content item in the first user interface when the first content does not include a sub-content item of a certain type at the current playback position avoids errors in adding content to the library of the user, thereby enhancing user interaction with the electronic device.

In some embodiments, the current playback position in the first content is a first playback position (e.g., as described above), the first user interface includes the representation of the first sub-content item and the first selectable option that is selectable to add the first sub-content item to the library of the user of the first electronic device, such as in FIG. 6C (e.g., in accordance with the determination that the first content includes the first sub-content item (e.g., audio, video and/or a combination of audio and video) at the current playback position of the first content).

In some embodiments, after the current playback position of the first content progresses away from the first playback position to a second playback position, different from the first playback position such as in FIG. 6F (e.g., as described above), in accordance with a determination that the first content includes a third sub-content item (e.g., audio, video and/or a combination of audio and video, having one or more of the characteristics of the first and/or second sub-content items described herein) at the second playback position of the first content, and does not include the first sub-content item at the second playback position of the first content, such as in FIG. 6F (e.g., similar to as described previously), the first electronic device displays, via the display generation component, the first user interface, including a representation of the third sub-content item, such as representation 622b in FIG. 6F (e.g., having one or more of the characteristics of the representations of the first sub-content item and/or the second sub-content item described previously), and a third selectable option that is selectable to add the third sub-content item to the library of the user of the first electronic device, such as selectable option 624b in FIG. 6F (e.g., having one or more of the characteristics of the first and/or second selectable options described previously), wherein the first user interface does not include the representation of the first sub-content item and the first selectable option that is selectable to add the first sub-content item to the library of the user of the first electronic device, such as in FIG. 6F. Updating the first user interface based on changes to which sub-content item is at the current playback position of the first content avoids errors in adding content to the library of the user, thereby enhancing user interaction with the electronic device.

In some embodiments, in accordance with the determination that the first content includes the first sub-content item (e.g., audio, video and/or a combination of audio and video) at the current playback position of the first content (e.g., as described previously), in accordance with a determination that the first content includes a first actor at the current playback position of the first content, such as Jung Kim in FIG. 6C (e.g., a first actor or actress is in the currently playing scene and/or in the frame of the currently playing scene of the first content at the second electronic device), the electronic device displays, in the first user interface, a representation of the first actor, including information about the first actor, such as representation 620a. In some embodiments, the representation of the first actor has one or more of the characteristics of the representations of the first and/or second sub-content items. In some embodiments, the representation of the first actor is displayed concurrently with the representations of the first and/or second sub-content items in the first user interface. In some embodiments, the representation of the first actor includes an image of the first actor (e.g., a photo), a name of the first actor, an age of the first actor, and/or other information about the first actor. In some embodiments, the representation of the first actor is selectable to cause the first electronic device to display a user interface of a media application at the first electronic device (e.g., different from the remote control application at the first electronic device), wherein the user interface of the media application is dedicated to the first actor (e.g., includes selectable options and/or information about other content the first actor has appeared in, other content the actor has produced, other content the actor was a writer for, and/or other content that the actor had a guest appearance in). In some embodiments, selectable options in the media user interface are selectable to initiate playback of the content corresponding to the selected option on the first electronic device and/or the second electronic device. In some embodiments, the media application is an application from which content (e.g., movies, television shows, podcasts, etc.) is accessible from the first electronic device, that can be played at the first electronic device and/or the second electronic device. In some embodiments, once playback progresses and the first actor is no longer in the first content at the current playback position of the first content, the first electronic device optionally ceases displaying the representation of the first actor in the first user interface.

In some embodiments, in accordance with the determination that the first content includes the first sub-content item (e.g., audio, video and/or a combination of audio and video) at the current playback position of the first content (e.g., as described previously), in accordance with a determination that the first content does not include the first actor at the current playback position of the first content, such as not including Jung Kim in FIG. 6E (e.g., the first actor or actress is not in the currently playing scene and/or not in the frame of the currently playing scene of the first content at the second electronic device), the first electronic device forgoes displaying, in the first user interface, the representation of the first actor and the information about the first actor, such as not displaying representation 620a in FIG. 6E. In some embodiments, if the first content includes a second actor at the current playback position of the first content, the first electronic device displays, in the first user interface, a representation of the second actor, including information about the second actor (optionally having one or more of the characteristics of the representation of the first actor described above). Providing access to information about an actor of a currently playing content item on a different device reduces the amount of input needed to find such information, and avoids errors in accessing such information, thereby enhancing user interaction with the first electronic device.

In some embodiments, while displaying the first user interface including the representation of the first sub-content item, the first electronic device receives, via the one or more input devices, a first input corresponding to selection of the representation of the first sub-content item, such as selection of representation 622c in FIG. 6H. In some embodiments, the first input includes a touch input on the first selectable option. In some embodiments, the first input includes a mouse click on the first selectable option.

In some embodiments, in response to receiving the first input, the first electronic device displays, via the display generation component, a second user interface of a content application (e.g., an application different from the remote control application), wherein the second user interface corresponds to the first sub-content item, such as user interface 602c in FIG. 6I. In some embodiments, the second user interface is different from the first user interface, and the first electronic device optionally ceases display of the first user interface in response to detecting the first input. In some embodiments, the content application is an application on the first electronic device via which content (e.g., music, songs, music videos, or the like-more generally, content of the same type as the type of content of the first sub-content item and the second sub-content item) is accessible on the first electronic device. In some embodiments, the content application is different from the media application described above that is displayed in response to detecting selection of a representation of an actor. In some embodiments, the second user interface is a user interface dedicated to the first sub-content item in the content application (e.g., a user interface that includes information about the artist who created and/or performs the first sub-content item, information about the studio that produced the first sub-content item, and/or information about an album that includes the first sub-content item). In some embodiments, the second user interface includes selectable options to: 1) play the first sub-content item at the first electronic device; 2) add the first sub-content item to the library of the user of the first electronic device; 3) play through a plurality of sub-content items that are part of an album that includes the first sub-content item; and/or 4) share the first sub-content item with another user (e.g., via messaging or email). In some embodiments, in response to detecting selection of the representation of the second sub-content item, the first electronic device displays a third user interface of the content application, wherein the third user interface corresponds to the second sub-content item (instead of the first sub-content item), and the third user interface optionally has one or more of the characteristics of the second user interface described above. In some embodiments, selecting the representation of the first and/or second sub-content items does not automatically add the first and/or second sub-content items to the library of the user. Providing access to information about the sub-content item of the currently playing content item on a different device reduces the amount of input needed to find such information, and avoids errors in accessing such information, thereby enhancing user interaction with the first electronic device.

In some embodiments, the current playback position in the first content is a first playback position (e.g., as described above), and the first user interface includes the representation of the first sub-content item and the first selectable option that is selectable to add the first sub-content item to the library of the user of the first electronic device, such as in FIG. 6G (e.g., in accordance with the determination that the first content includes the first sub-content item (e.g., audio, video and/or a combination of audio and video) at the current playback position of the first content).

In some embodiments, after the current playback position of the first content progresses away from the first playback position (e.g., as described above) and while the second electronic device is playing second content, different from the first content, such as in FIG. 6H (e.g., the second electronic device has progressed through the end of the first content, and has switched to playing the second content automatically because the second content is the next content in a playback queue of content at the second electronic device, or the second electronic device has detected user input for switching to the second content), the first electronic device displays, via the display generation component, the first user interface that includes, in accordance with a determination that the second content includes a third sub-content item (e.g., audio, video and/or a combination of audio and video) at a current playback position of the second content, such as Song 3 in FIG. 6H, a representation of the third sub-content item, such as representation 622c (e.g., such as described above with respect to the representations of the first and/or second sub-content items), and a third selectable option that is selectable to add the third sub-content item to the library of the user of the first electronic device, such as selectable option 624c in FIG. 6H (e.g., such as described above with respect to the first and/or second selectable options). In some embodiments, the first electronic device maintains display of the first user interface even as the second electronic device transitions from playing the first content to playing the second content. In some embodiments, the second content is a different television show episode, a different movie, or more generally a different item of content than the first content. In some embodiments, the third sub-content item is the same or different from the first and/or second sub-content items. In some embodiments, the third sub-content item has one or more of the characteristics of the first and/or second sub-content items. Providing for the adding of a sub-content item of a currently playing content item on a different device to a library of a user reduces the amount of input needed to identify and/or add such content to the library of the user, and avoids errors in adding such content to the library of the user, thereby enhancing user interaction with the first electronic device.

In some embodiments, the first user interface further includes a third selectable option that is selectable to display information about the first content playing on the second electronic device, such as navigation element 616a. In some embodiments, in response to detecting selection of the third selectable option, the first electronic device displays a user interface of the remote control application that includes the information about the first content (and optionally ceases display of the first user interface). In some embodiments, the information about the first content includes information such as a cover image of the first content, a title of the first content, a duration of the first content, a parental rating of the first content (e.g., G, PG-13, R, etc.), the names of actors included in the first content, a textual description or summary of the first content, and the like. In some embodiments, if the second electronic device were playing second content, different from the first content, the first user interface would include a fourth selectable option that is selectable to display information about the second content rather than the first content (e.g., analogously as described above with respect to the information about the first content). Providing access to information about the first content playing on a different device reduces the amount of input needed to find such information, and avoids errors in accessing such information, thereby enhancing user interaction with the first electronic device.

In some embodiments, the first user interface further includes a third selectable option that is selectable to display representations of one or more content items that are in a content queue including the first content, such as navigation element 616c, wherein the content queue is associated with the second electronic device (e.g., the content queue represents the content items that the second electronic device will automatically play through, sequentially, unless user input is received that would cause the second electronic device to deviate from the playback queue). In some embodiments, in response to detecting selection of the third selectable option, the first electronic device displays a user interface of the remote control application that includes the information about the content queue (and optionally ceases display of the first user interface). In some embodiments, the representations of the content items are displayed in an order corresponding to the order in which the content items are ordered in the queue. In some embodiments, a given representation of the representations of the content items includes: 1) an image of the content item, 2) a title of the content item, 3) a parental rating of the content item, 4) a type of the content item (e.g., a movie or television episode), and/or 5) a duration of the content item. In some embodiments, in response to detecting input directed to the user interface including the representations of the content items in the content queue, the first electronic device updates or modifies the content queue associated with the second electronic device. For example, input at the first electronic device can be provided to add or remove content items from the content queue, or to reorder the content items in the content queue. Providing access to information about the content queue playing on a different device reduces the amount of input needed to find such information, and avoids errors in accessing such information, thereby enhancing user interaction with the first electronic device.

In some embodiments, playback of the first content at the second electronic device is maintained in response to input directed to the first user interface at the first electronic device, such as the playback of Content A and/or Content B being maintained at device 500 in FIGS. 6A-6L even while device 511 responds to the various interactions described in method 700 and/or with reference to FIGS. 6A-6L. Thus, in some embodiments, one or more or all of the interactions with the first electronic device described above do not interrupt or change the playback of the content on the second electronic device, unless the input detected at the first electronic device is input for interrupting or changing such playback (e.g., pausing, skipping, changing the content queue, or the like). Maintaining playback of the content on the second electronic device independent of the interactions that occur with the first electronic device avoids errors in playback of the content at the second electronic device, and thus reduces the need for input at the first electronic device for correcting such errors, thereby enhancing user interaction with the electronic devices.

It should be understood that the particular order in which the operations in method 700 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., as described with respect to FIGS. 1A-1B, 3, 5A-5C) or application specific chips. Further, the operations described above with reference to FIG. 7 are, optionally, implemented by components depicted in FIGS. 1A-1B. For example, displaying operation 702a is, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology potentially involves the gathering and use of data available from specific and legitimate sources to display user interfaces and/or information associated with devices in communication with an electronic device. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information, usage history, handwriting styles, images collected by devices etc.

The present disclosure recognizes that the use of such personal information data in the present technology can be used to the benefit of users. For example, the personal information data can be used to automatically perform operations with respect to suggesting representations of applications to incorporate into to a scrollable user interface. Accordingly, use of such personal information data enables users to enter fewer inputs to perform an action with respect to displaying and interacting with content. Further, other uses for personal information data that benefit the user are also contemplated by the present disclosure. For instance, user preferences may be used to identify actors or songs associated with content playing on another electronic device.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the user is able to configure one or more electronic devices to change the discovery or privacy settings of the electronic device. For example, the user can select a setting that only allows an electronic device to access certain information when detecting actors or songs associated with content playing on another electronic device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, the actors and/or songs in the content playing on the other electronic device can be identified based on aggregated non-personal information data or a bare minimum amount of personal information, such as the user preferences being handled only on the user's device or other non-personal information.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at a first electronic device in communication with a display generation component and one or more input devices:
while the first electronic device is in communication with a second electronic device that is currently playing first content, displaying, via the display generation component, a first user interface that includes:
in accordance with a determination that the first content includes a first sub-content item at a current playback position of the first content:
a representation of the first sub-content item; and
a first selectable option that is selectable to add the first sub-content item to a library of a user of the first electronic device; and
in accordance with a determination that the first content includes a second sub-content item, different from the first sub-content item, at the current playback position of the first content:
a representation of the second sub-content item; and
a second selectable option that is selectable to add the second sub-content item to the library of the user of the first electronic device.

2. The method of claim 1, wherein:
playing the first content includes the second electronic device displaying visual content included in the first content via a second display generation component in communication with the second electronic device, and
the first sub-content item is audio content included in the first content.

3. The method of claim 1, wherein the first user interface is a user interface of a remote control application on the first electronic device, wherein the remote control application is for controlling the second electronic device from the first electronic device.

4. The method of claim 3, further comprising:
before displaying the first user interface, and while displaying, via the display generation component, a second user interface of the remote control application, different from the first user interface, wherein the second user interface includes one or more control elements for controlling the second electronic device, receiving, via the one or more input devices, a first input including selection of a first selectable option in the second user interface; and
in response to receiving the first input, displaying, via the display generation component, the first user interface.

5. The method of claim 1, wherein the current playback position in the first content is a first playback position, the first user interface includes the representation of the first sub-content item and the first selectable option that is selectable to add the first sub-content item to the library of the user of the first electronic device, and the first sub-content item is a content item of a first type, the method further comprising:
after the current playback position of the first content progresses away from the first playback position to a second playback position, different from the first playback position:
in accordance with a determination that the first content item includes no sub-content item of the first type at the second playback position, displaying, via the display generation component, the first user interface, wherein the first user interface does not include a representation of a sub-content item, and does not include a selectable option that is selectable to add a sub-content item to the library of the user of the first electronic device.

6. The method of claim 1, wherein the current playback position in the first content is a first playback position, the first user interface includes the representation of the first sub-content item and the first selectable option that is selectable to add the first sub-content item to the library of the user of the first electronic device, the method further comprising:
after the current playback position of the first content progresses away from the first playback position to a second playback position, different from the first playback position:
in accordance with a determination that the first content includes a third sub-content item at the second playback position of the first content, and does not include the first sub-content item at the second playback position of the first content, displaying, via the display generation component, the first user interface, including:
a representation of the third sub-content item; and
a third selectable option that is selectable to add the third sub-content item to the library of the user of the first electronic device,
wherein the first user interface does not include the representation of the first sub-content item and the first selectable option that is selectable to add the first sub-content item to the library of the user of the first electronic device.

7. The method of claim 1, further comprising:
in accordance with the determination that the first content includes the first sub-content item at the current playback position of the first content:
in accordance with a determination that the first content includes a first actor at the current playback position of the first content, displaying, in the first user interface, a representation of the first actor, including information about the first actor; and in accordance with a determination that the first content does not include the first actor at the current playback position of the first content, forgoing displaying, in the first user interface, the representation of the first actor and the information about the first actor.

8. The method of claim 1, further comprising:
while displaying the first user interface including the representation of the first sub-content item, receiving, via the one or more input devices, a first input corresponding to selection of the representation of the first sub-content item; and
in response to receiving the first input, displaying, via the display generation component, a second user interface of a content application, wherein the second user interface corresponds to the first sub-content item.

9. The method of claim 1, wherein the current playback position in the first content is a first playback position, and the first user interface includes the representation of the first sub-content item and the first selectable option that is selectable to add the first sub-content item to the library of the user of the first electronic device, the method further comprising:
after the current playback position of the first content progresses away from the first playback position and while the second electronic device is playing second content, different from the first content, displaying, via the display generation component, the first user interface that includes:
in accordance with a determination that the second content includes a third sub-content item at a current playback position of the second content:
a representation of the third sub-content item; and
a third selectable option that is selectable to add the third sub-content item to the library of the user of the first electronic device.

10. The method of claim 1, wherein the first user interface further includes a third selectable option that is selectable to display information about the first content playing on the second electronic device.

11. The method of claim 1, wherein the first user interface further includes a third selectable option that is selectable to display representations of one or more content items that are in a content queue including the first content, wherein the content queue is associated with the second electronic device.

12. The method of claim 1, wherein playback of the first content at the second electronic device is maintained in response to input directed to the first user interface at the first electronic device.

13. An electronic device in communication with one or more input devices and a display generation component, the electronic device comprising:
one or more processors;
memory storing one or more programs, wherein the one or more programs are configured to be executed by the one or more processors, the one or more programs including instructions for:
while the first electronic device is in communication with a second electronic device that is currently playing first content, displaying, via the display generation component, a first user interface that includes:
in accordance with a determination that the first content includes a first sub-content item at a current playback position of the first content:
a representation of the first sub-content item; and
a first selectable option that is selectable to add the first sub-content item to a library of a user of the first electronic device; and
in accordance with a determination that the first content includes a second sub-content item, different from the first sub-content item, at the current playback position of the first content:
a representation of the second sub-content item; and
a second selectable option that is selectable to add the second sub-content item to the library of the user of the first electronic device.

14. A non-transitory computer readable storage medium storing one or more programs, the one or more programs comprising instructions, which when executed by one or more processors of an electronic device in communication with one or more input devices and a display generation component cause the electronic device to perform a method comprising:
while the first electronic device is in communication with a second electronic device that is currently playing first content, displaying, via the display generation component, a first user interface that includes:
in accordance with a determination that the first content includes a first sub-content item at a current playback position of the first content:
a representation of the first sub-content item; and
a first selectable option that is selectable to add the first sub-content item to a library of a user of the first electronic device; and
in accordance with a determination that the first content includes a second sub-content item, different from the first sub-content item, at the current playback position of the first content:
a representation of the second sub-content item; and
a second selectable option that is selectable to add the second sub-content item to the library of the user of the first electronic device.
